(19) United States
(12) Patent Application Publication
(10) Pub. No.: US 2023/0245573 A1
(43) Pub. Date: Aug. 3, 2023

(54) APPARATUS, METHOD AND SYSTEM FOR PROVIDING USER DEFINED CONSTRAINTS FOR AIRCRAFT ROUTE PLANNING

(71) Applicant: SMARTSKY NETWORKS LLC, Morrisville, NC (US)

(72) Inventors: Blane Rockafellow, Raleigh, NC (US); Brian Rudloff, Satellite Beach, FL (US); Thomas Gahagen, Holly Springs, NC (US); Bryan Trainum, Williamsburg, VA (US)

(21) Appl. No.: 18/009,500

(22) PCT Filed: May 19, 2021
(86) PCT No.: PCT/US2021/033068

§ 371 Date: Dec. 9, 2022

Related U.S. Application Data
(60) Provisional application No. 63/038,284, filed on Jun. 12, 2020.

(51) Int. Cl. G08G 5/00

(52) U.S. Cl. CPC G08G 5/0039; G08G 5/0013; G08G 5/006; G08G 5/0021

(57) ABSTRACT

An advisory module may include processing circuitry configured to receive route planning information related to route optimization for travel of an aircraft between a starting location and a destination, generate a flight path associated with the route optimization, receive a user defined constraint via a user interface, and generate an updated flight path based on the user defined constraint.

### CROSS-REFERENCE TO RELATED APPLICATIONS

This application claims priority under 35 U.S.C. §119(e) to U.S. Provisional Application No. 63/038,284 filed Jun. 12, 2020, which is expressly incorporated by reference herein in its entirety.

### TECHNICAL FIELD

Example embodiments generally relate to the aviation industry and, more particularly, relate to the ability to provide user defined constraints in connection with evaluation and definition of routes associated with aircraft.

### BACKGROUND

The market for mobile device-based applications is currently populated with a large number of products that provide pilots with improved means for traditional flight planning (e.g., ForeFlight, Garmin Pilot, Jeppesen TC, JeppVFR, WingXPro, Fly!, My Wingman, ARINC Direct, AeroVie, Xavion, RocketRoute, iFlightPlanner, FltPlan.com, and others). These products perform a useful function in improving the traditional, largely manual means of planning flights through electronic applications (apps) on both mobile devices and in flight deck forward field of view displays. These apps streamline the pre-flight planning process through simplified access to integrated forms of weather, airspace, and aircraft data, as well as through automating calculations formerly requiring manual processing.

However, even though each of these products uses various different pieces of information to improve route planning capabilities, and some can even purport to generate “optimized” routing services for some parameters, the products generally do not enable continuous or periodic updating of flights in real time. Moreover, these products also generally perform any purported optimization on the basis of avoiding certain constraints such as closed airspace and convective weather, which are deeply integrated into the code of the corresponding application. While there may be certain settings that the user can adjust, which may set sensitivity preferences or maximum/minimum deviation limits from a great circle (or other defined) route, the constraints are generally “built-in” in such a way that the user is more or less stuck with the built-in constraints of the corresponding product.

The products may be updated by the developers to add new constraints if there is significant demand for a given feature. However, such updates typically require expensive, custom development that can take several weeks or months. Accordingly, it may be desirable to provide an improved way for constraints to be added to a product.

### BRIEF SUMMARY OF SOME EXAMPLES

Some example embodiments may therefore be provided to overcome some of the limitations described above. Although not required, example embodiments may be provided within the context of a system that provides improved connectivity to support real-time, optimal management of flight paths in the context of various objective parameters. However, unlike conventional systems, example embodiments may consider not only built-in constraints, but also user defined constraints with respect to the route planning and/or optimization conducted.

In one example embodiment, a trajectory management module is provided. The trajectory management module may include processing circuitry configured to receive route planning information related to route optimization for travel of an aircraft between a starting location and a destination, generate a flight path associated with the route optimization, receive a user defined constraint via a user interface, and generate an updated flight path based on the user defined constraint.

In another example embodiment, a method for conducting route planning and/or optimization is provided. The method may include receiving route planning information related to route optimization for travel of an aircraft between a starting location and a destination, generating a flight path associated with the route optimization, receiving a user defined constraint via a user interface, and generating an updated flight path based on the user defined constraint.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an aircraft moving through the coverage areas of different base stations over time in accordance with an example embodiment;

FIG. 2 illustrates a block diagram of a system for employing a trajectory management module in an air-to-ground communication setting in accordance with an example embodiment;

FIG. 3 illustrates the trajectory management module according to an example embodiment;

FIG. 4 illustrates an exclusionary object and an inclusionary object in accordance with an example embodiment;

FIG. 5 illustrates a different avoidance strategy than the example of FIG. 4 in accordance with an example embodiment;

FIG. 6 illustrates a user defined constraint being avoided by fly under in accordance with an example embodiment;

FIG. 7 illustrates a user defined constraint being avoided by fly over in accordance with an example embodiment;

FIG. 8 illustrates a block diagram of a method for performing an example advisory related function with user defined constraints in accordance with an example embodiment;

FIG. 9 illustrates example code in accordance with an example embodiment; and

FIG. 10 illustrates another set of example code in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

Furthermore, as used herein, the term “or” is to be interpreted as a logical operator that results in true whenever one or more of its operands are true. As used herein, the terms “data,” “content,” “information” and similar terms may be used interchangeably to refer to data capable of being transmitted, received, processed and/or stored in accordance with example embodiments. Thus, use of any such terms should not be taken to limit the spirit and scope of example embodiments.

As used herein, the terms “component,” “module,” and the like are intended to include a computer-related entity, such as but not limited to hardware, firmware, or a combination of hardware and software. For example, a component or module may be, but is not limited to being, a process running on a processor, a processor, an object, an executable, a thread of execution, and/or a computer. By way of example, both an application running on a computing device and/or the computing device can be a component or module. One or more components or modules can reside within a process and/or thread of execution and a component/module may be localized on one computer and/or distributed between two or more computers. In addition, these components can execute from various computer readable media having various data structures stored thereon. The components may communicate by way of local and/or remote processes such as in accordance with a signal having one or more data packets, such as data from one component/module interacting with another component/module in a local system, distributed system, and/or across a network such as the

Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

As mentioned above, the typical route planning service or application includes only built-in constraints. Thus, although developers may perform continued development in order to add features or constraints, the user is incapable of defining his/her own constraints. Example embodiments provide a route planning (or route optimization) service that is further configured to enable a user to input user defined constraints. For example, the user may be enabled to define a multi-dimensional object (or a series of multi-dimensional objects) for consideration by a routing algorithm with respect to determining a flight route (or route plan), which may then be optimized to minimize cost in time and/or fuel while avoiding both built-in constraints of the system, and the user defined constraint(s). Accordingly, example embodiments may enable route optimization not only in view of built-in constraints that are programmed into the system beforehand, but also in view of user defined constraints that can be generated by the user during operation (and in-flight).

In general terms, the preparation of a flight plan, which includes the selection of a route will, if the route is followed, define corresponding costs in terms of consumption or generation of certain parameters or values that are likely to correspond to the route. These costs in terms of consumption or generation of parameters may include time consumption, fuel consumption, and/or the like. Prior to beginning a flight, the likely costs associated with the flight plan can be calculated based on current conditions. The current conditions may include weather conditions or weather cells in addition to the start and destination points for the route, and the characteristics of the aircraft flying the route. Applications can be employed to suggest improvement or even optimization of a route in order to minimize or maximize any desired parameters in light of the current conditions. The suggested or optimized route may then be presented to the user as guidance for acceptance and adoption, or for the user to request routing from flight controllers corresponding to the optimized route.

However, within this context, it should be understood that many so called “optimized” routes could exist between two points over time due to the potential for dynamic changing of conditions. Thus, it should be appreciated that the calculation of an optimized route is really just the calculation of a theoretical optimized route for a given instant in time based on the parameters in existence (or defined) for the route at that given instant in time. As the route progresses, and current as well as forecast conditions change, the optimization actually also very likely changes. Accordingly, real time updating of conditions and optimization options is an important enabling objective to the improvement of flight planning.

To account for these changing conditions (and therefore changing optimizations), route planning services may be configured to continuously update or replan routes over five dimensions (i.e., the three dimensions of airspace volume, along with additional dimensions for current and future time), which may be referred to as CRSDT. This type of continuous route replanning is described, for example, in U.S. Pat. No. 9,417,070, U.S. Pat. No. 8,594,917, U.S. Pat. No. 8,554,458, and U.S. patent application Ser. No. 16/339,191, each of which is incorporated herein by reference in its entirety. However, even these powerful optimization tools operate with built-in constraints. Although the built-in constraints may include dynamic objects (e.g., weather or other aircraft), even those dynamic objects are entered into the system and dealt with by the system in ways that are pre-programmed and out of the reach of the user (except, as noted above, perhaps with respect to changing sensitivity settings). Example embodiments enable the user to input both dynamic and fixed objects or other user defined constraints. The CRSDT planning and route optimization can then be accomplished in consideration of not only fixed or dynamic objects that are generated based on built-in constraints, but also on fixed or dynamic objects that are generated as user defined constraints. Furthermore, the user defined constraints may not only define areas to be avoided, but areas that are instead to be preferred (or inside which the aircraft should desirably stay). This gives the operator (e.g., pilot, flight controller, flight planner, etc.) significantly more flexibility in defining constraints around which optimization strategies may be employed. For example, not only can the user instantaneously define exclusion areas for any reason (e.g., avoidance of overflight fees, avoidance of poor wireless connectivity areas, avoidance of airspace proximate to other objects or events, etc.), but the user can alternatively define preferred areas inside which the area should stay, again for any reason (e.g., maintaining best wireless connectivity for users onboard, staying in assigned airspace for certain events, etc.).

Example embodiments may therefore provide the capability to route optimization using real time data during flight, that also take into account both the typical built-in system constraints along with user defined constraints. As such, example embodiments also deliver dynamically updatable user constraints using real time situationally specific information that may be available outside of typical route management and route optimization applications in order to further increase the value of the services otherwise provided by typical route management and route optimization applications.

Example embodiments provide a system that utilizes real time connectivity to a plurality of in-flight aircraft, and real time updating of changing flight conditions to provide an in-flight service that delivers not only optimized routes, but dynamically updated optimized routes that further include evaluation of user defined constraints. Thus, the real time connectivity aspect of example embodiments may be a backbone upon which other evaluation tools may be built since the real time connectivity not only enables accurate route optimization, but enables setting (or changing) the constraints (built-in and user defined) that are employed dynamically and being responsive to the same. Accordingly, some example embodiments may implement a computer executable application or module, employed via air-to-ground, air-to-air, or satellite communication-based aircraft connectivity that further integrates to the internet and/or terrestrial based communication. The application or module may employ methods for dynamic flight path management for computing and optimizing flight paths, and for providing input techniques to further enable users to provide entry of user defined constraints as described above. The capability disclosed herein may be implemented using trajectory optimization methods employing (for example) kinetic, kinematic, point-mass, as well as six-degree-of-freedom path models.

Within the aviation industry, the process for management of dynamically interacting flight paths may be referred to as CRSDT, translated to mean Continuous Replanning of Five-Dimensional Trajectories for continuous replanning in five dimensions. As noted above, some example embodiments may employ a “Flight 5D” application module (or Destination Certainty application module), which may be referred to as a continuous replanning module. The continuous replanning module may be configured to employ the technologies for route planning and optimization described herein. However, example embodiments may be further augmented with a user defined constraint module configured to enable the user to easily define a user defined constraint (or multiple such constraints). Thus, the user defined constraint module may be built onto a continuous replanning module that is configured to account for both the external and internal factors that bound the future flight path solution space, based on the ability, through a real time aviation connectivity solution, to continually ingest updated forecasts of all factors affecting all of the future of any given flight path.

The approach accounts for built-in constraints associated with external factors, which may include airspace exclusions, architectures and procedures, winds and temperatures aloft, storms, icing, volcanic ash and turbulence, all of which may be provided to the continuous replanning module of the base system as baseline dynamic information that is communicated to the system before and during a flight, and is built-in for normal operation of the continuous replanning module. This baseline dynamic information may further include other air traffic, including air traffic management flow control initiatives for congestion management. Other built-in constraints may include internal factors, which may include pilot or operator policies and preferences for desired time of arrival, avoidance of turbulence or icing or other flight hazards, fuel burn minimization, and cost minimization. Additional internal factors include current and future aircraft weight, speed, configuration of landing gear and controls, and effects on performance of abnormal conditions such as failure of an engine or other aircraft system such as cabin environmental, hydraulics, electrical, communications systems, or other factor affecting otherwise normal flight operations. Collectively, the combination of these built-in variables and constraints create a flight path management challenge that no pilot, flight crew, or fleet manager can continually update to achieve optimal solutions for a complete flight path from origin or current position to destination, during flight. However, the continuous replanning module may be configured to enable optimization of these built-in variables and constraints in-flight, and in a dynamic and responsive way. Moreover, as noted above, the inclusion of the user defined constraint module may further enable the system to accommodate user defined constraints

Of note, although some settings, goals or sensitivity values may be input by the user (e.g., selecting a minimization strategy versus maximization strategy for a parameter, selecting a minimum or maximum distance to an object (i.e., policies), etc.), these user interactions with the system are not considered to be user defined constraints within the context of this disclosure. To the contrary, as used herein, the term user defined constraints may be defined as a multi-dimensional object inserted by a user into a route tracking or optimization system. The multi-dimensional nature of the object includes both space and time dimensions. Thus, for example, the object may have a three dimensional (3D) geometric shape, but also have a start and end time. The object may therefore have minimum altitude, maximum altitude, boundaries in latitude and longitudinal coordinates on its sides, and may exist for a given period of time (i.e., having a start and/or end time). However, in other cases, the object may be assigned a moving direction (or directions—since direction change at a given time may be prescribed) and a corresponding moving speed. In some examples, the geometry of the object may be defined using GeoJSON format, although other formats are also possible. Moreover, as noted above, the object (i.e., the user defined constraint) may be assigned a value or status indicator in order to designate the object for avoidance or inclusion during route determination (or route optimization).

If designated for avoidance, the route tracking or optimization system may be prohibited from suggesting or selecting routes that pass through any part of the object forming the user defined constraint. Alternatively or additionally, the route tracking or optimization system may define a very high cost associated with any routes passing through the object in order to disfavor or make such routes less likely to be suggested or selected. When an object is designated for avoidance, the object may be referred to as an exclusionary user defined constraint. As such, exclusionary user defined constraints may be used to designate prohibited or unfavorable areas to which travel should be either not possible or discouraged.

Meanwhile, if selected for inclusion, the route tracking or optimization system may be constrained to stay within the object (e.g., for a given period of time). Alternatively or additionally, the route tracking or optimization system may be configured to assign a very low cost associated with any routes passing through the object in order to favor or make such routes more likely to be suggested or selected. When an object is designated for inclusion, the object may be referred to as an inclusionary user defined constraint. As such, inclusionary user defined constraints may be used to designate preferred areas to which travel should be inclusively limited or encouraged.

Beyond just calculating optimal solutions in real time, the power of in-flight connectivity further empowers example embodiments to enable users (e.g., pilots, flight planners, flight controllers, etc.) to influence the calculation of suggested routes based on user preferences, or based on information known to the user, but not otherwise known to the route tracking or optimization system through the typical ways the system becomes aware of such information based on the built-in constraints of the system (e.g., from weather reporting services, flight advisory services, geographical databases, etc). This inclusionary or exclusionary object editing capability provides users with vastly improved abilities for influencing the determination of optimal routes with respect to issues of interest to the user. Accordingly, the pilot, air traffic controllers, fleet managers, and/or the like may make fully informed decisions about routing. Accordingly, for example, preferences or priorities of the pilot (or other users mentioned above) can be fully integrated into optimization in certain instances where the user's judgement dictates that certain areas should be treated in a certain way (e.g., for inclusion or exclusion). As an example, the pilot may be informed that certain areas require a fee for flyover, or that conditions have developed in a particular area of a flight path that have made the flight path previously suggested no longer desirable to traverse. Under normal circumstances where the pilot (or fleet manager) is only given routes suggested based on built-in constraints, the pilot (or fleet manager) must depart from the identified route without any optimization possible for the departure. With example embodiments, the entry of a user defined constraint causes the departure from the prior suggested route to also be optimized.

As noted above, the flight path management aspect of example embodiments may only be a portion of the overall capabilities that the system provides. In this regard, example embodiments may not only include a module that manages airborne trajectories, but may further provide the ability to enter user defined constraints that then fully get integrated into optimization strategies and decisions of the system. Example embodiments may be implemented in a variety of computing and communications architectures involving airborne and ground (cloud)-based alternatives. A continuous replanning module could be operated as a Web service or desktop application if supplied with all the data required for the computational optimization of the flight path and a data communication link to and from the aircraft, and may be further augmented with the user defined constraint module. The continuous replanning and user defined constraint modules may be executed on any number of computing platforms, including mobile devices such as smart phones or tablet-based personal electronic devices, or in the avionics panel of an aircraft, or in devices that provide aural, tactile, or visual cues or are “wearable” by pilots. Furthermore, computations associated with flight path optimization and implementation of user defined constraints can be effectively conducted in data centers (or the “cloud”) as means of alternative architectures for generating and providing advisories to the pilot or a dispatcher, where the advisories are provided wirelessly to the aircraft while in-flight along with the context information and comparative data described herein. However, computations associated with example embodiments could also or alternatively be performed in the air or as a combination of air and ground executed steps. That said, given the ability for real time connectivity that is advantageously employed in connection with example embodiments, the possibility of minimizing the amount of hardware in the air may be taken advantage of to lighten the weight and cost of equipment that is airborne without sacrificing anything in terms of capability. As such, by employing cloud-based computation and real time connectivity bandwidth-enabled access to the data and information required and the means of computing the data-driven flight path advisories for the aircraft operator and/or ground operators are provided, along with the user defined constraint aspects described herein to augment the capabilities provided. Pilots, air traffic controllers, drivers and/or fleet managers may therefore be provided with continuously updated information about the best heading, speed, altitude, routing, and rate of climb/descent to fly from wherever they are in the airspace, to their primary or alternate destination, while consideration is given not only to the traditional, built-in constraints of the continuous replanning module, but also in consideration of the user defined constraints.

Example embodiments may generate flight trajectory solutions using a computational platform that has sufficient speed and is fed by sufficient data to produce advisory information that is relevant in real-time and in fast-time, and may further evaluate those solutions, also in real-time and in fast-time to provide the proof points-related feedback described herein. Although not required, through the integration of a computational platform in a system that includes Air-to-Ground (ATG) 4G LTE WiFi access (for example) and/or ADS-B 978 MHz UAT FIS-B and TIS-B data (for example), example embodiments may enable the generation of regular updates to flight path optimizations that satisfy user preferences and policies for path objectives, and demonstrate also the degree of optimization relative to alternative and potentially impacts across multiple factors that are candidates for optimization. An example of an ATG access system that may employ an example embodiment is described below. However, it should be appreciated that example embodiments may also employ air-to-air or satellite components in some cases, either alone or in combination with each other and ATG components. Thus, for example, some embodiments could be practiced in connection with connectivity provided by low earth orbit (LEO) satellites, or any other type of in-flight connectivity. Meanwhile, still other embodiments could be practiced independent of any in-flight connectivity.

In an ATG context, each base station is typically one of a plurality of base stations that are deployed on the ground (or in the air) to be partially overlapping with adjacent base stations to provide continuous and uninterrupted coverage over a particular geographic area. The base stations are interconnected with each other to form a network, and may also be interconnected with other networks via a backhaul network or assembly. Mobile equipment that utilizes the communication network formed by these base stations includes devices on various aircraft. Moreover, the real-time, high bandwidth connection (in both directions) that may be offered by a full duplex ATG system may provide the opportunity for a “streaming black box” that can provide all data (and more) that is normally stored on board an aircraft for safety monitoring to equipment on the ground. Additionally, real-time flight tracking, even at granular levels of data, can be accomplished due to the high bandwidth and real-time connection.

In some examples, the ATG network may be designed to employ beamforming technology to communicate more efficiently and reliably. In this regard, for example, beams may be formed at or steered to desirable locations within a coverage area of a cell defined by a base station (or an aircraft) to extend range, reduce interference, and provide other enhanced communication capabilities. Whether the beams are steered or formed within this context, the control of the beams may be referred to as beamforming, and may be controlled by a beamforming control module. In some embodiments, the beamforming control module may be provided at mobile nodes of an air-to-ground network (e.g., aircraft), base stations of the network, and or at a network controller either at a central network location or in the cloud. The beamforming control module may utilize position information of both the base stations and the mobile nodes to determine (predictively or in real-time) where to steer beams to ensure continuous communication can be maintained both within an individual cell and when a handover to another cell is desirable.

In some embodiments, a base station employing beamforming may employ an antenna array to generate (e.g., form) or steer beams in the direction of the target device, enhancing the coverage range when the location of the device is known relative to the base station. When the location of the device is not known to the base station, then a beam may not be formed in the direction of the target device and the coverage range of the base station would effectively be reduced. To address this potential problem, it may be possible to utilize current and future position information of receiving stations and base stations to facilitate beamforming at either or both ends of the wireless communication links that are to be established.

In an ATG communications system, the end-user equipment (or receiving stations) may be installed or otherwise present on an aircraft or other aerial platform. Thus, as mentioned above, the utilization of position information may not simply involve knowledge of latitude and longitude, relative positioning, global positioning system (GPS) coordinates, and/or the like. Instead, knowledge of 3D position information including altitude may be required. Speed, course, and any other information descriptive of the current 3D position and likely future positions may also be helpful in some cases. When the 3D position of aircraft (or communication devices thereon) is known at a current time and in future time, this location-and time specific information may be employed by the wireless system to enhance the initial synchronization coverage range by enhancing beamforming. This 5D knowledge may also enhance the ability to track the trajectory of the aircraft and other aircraft to allow fully comprehensive communication of data in two directions to substantially enhance the quality of advisory services that react to real time internal and external factors.

In some cases, the knowledge of locations of fixed assets (i.e., base station locations) may be known in advance and, for example, may be stored at a location accessible to any or all assets of the network. Knowledge of movable device locations (e.g., aircraft) may be actively tracked for all devices (e.g., all aircraft or other known receiving devices on the aircraft) in the 3D airspace. As an example, aircraft (or devices thereon) taking off from an airport may access and synchronize with a base station near the airport. Once known to the wireless system, each device may periodically transmit position information (e.g., coordinates, altitude, and speed) to the serving base station. The base station may share the position information with a centralized server or other device in the core network, or in the cloud. The centralized server (or other processing device) may then track each device, compare the device location against a database of base stations in the system, and determine when a particular device may be moving into a different base station's coverage area. The device location may be shared with the new base station, and the new base station may then form a directional beam toward the wireless device to share synchronization information.

Example embodiments may therefore combine knowledge of fixed base stations positions with knowledge of moving receiving station positions (e.g., in 5D) to provide beamforming from both the aircraft (or devices thereon) and the base station when the device has not yet acquired a neighboring base station. Full beamforming coverage benefits may therefore be maintained within an ATG system, reducing the cost of network coverage and improving handoff reliability. The improved gain by using directed beams may enable aircraft to engage in communications with potentially distant base stations on the ground. Accordingly, an ATG network may potentially be built with base stations that are much farther apart than the typical distance between base stations in a terrestrial network thereby increasing the cost effectiveness of the ATG service.

With the ability to communicate with aircraft (and devices thereon) via focused and high-bandwidth, low latency beams established, communication of data to and from the aircraft can be greatly enhanced. Processing capabilities provided on the aircraft, on the ground, and/or in the cloud, may therefore be similarly enhanced to provide full integration of real time data into trajectory management for continuous replanning of dynamically interacting trajectories for optimal economic and safety related outcomes. The user defined constraint module, which may be configured to further provide the ability for user's to input objects into the system associated with optimized route planning (and presentation) may be a component of the trajectory management suite of services that are made available to network devices via a real-time intelligent system for managing assets and providing relevant information thereto while such assets are in-flight. This system may be referred to, or be a portion of, a “Skytelligence®” system. However, it should be appreciated that example embodiments could also be practiced before or after a given flight, and therefore may be practiced without any in-flight communication in some cases.

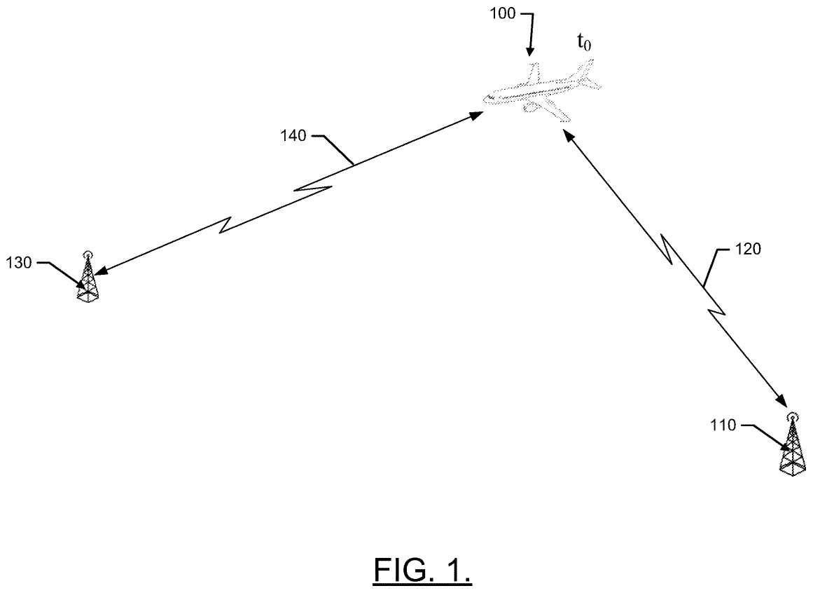

FIG. 1 illustrates a conceptual view of an aircraft moving through a coverage zone of different base stations to illustrate the beamforming aspects that may be integrated into an example embodiment. As can be seen in FIG. 1, an aircraft 100 may be in communication with a first base station (BS) 110 at time to via a wireless communication link 120. The aircraft 100 may therefore include wireless communication equipment onboard that enables the aircraft 100 to communicate with the first BS 110, and the first BS 110 may also include wireless communication equipment enabling communication with the aircraft 100. As will be discussed in greater detail below, the wireless communication equipment at each end may include radio hardware and/or software for processing wireless signals received at corresponding antenna arrays that are provided at each respective device in communication with their respective radios. Moreover, the wireless communication equipment of example embodiments may be configured to employ beamforming techniques to utilize directive focusing, steering, and/or formation of beams using the antenna arrays. Accordingly, for the purposes of this discussion, it should be assumed that the wireless communication link 120 between the aircraft 100 and the first BS 110 may be formed using at least one link established via beamforming. In other words, either the first BS 110 or the aircraft 100, or both, may include radio control circuitry capable of employing beamforming techniques for establishment of the wireless communication link 120.

The first BS 110 has a fixed position geographically and therefore position information regarding the location of the first BS 110 can be known. In some cases, an estimate of the coverage area defining the region in which first BS 110 is capable of providing wireless connectivity to aircraft may also be known or estimable (e.g., at the aircraft 100 and/or at the first BS 110 or another network location). Meanwhile, the position of the aircraft in 3D space may also be known or estimable at any given time (e.g., at the aircraft 100 and/or at the first BS 110 or another network location). Accordingly, flight tracking may be accomplished for UAS/UAV/UAM and other operations via automated airspace management. Furthermore, it should be appreciated that the coverage area of the first BS 110 may possibly be altitude dependent, in some cases. In this regard, for example, the latitudinal and longitudinal coverage area projected onto the surface of the earth for the first BS 110 may be differently sized for different altitudes. Accordingly, for example, based on the known position and coverage characteristics of the first BS 110 and the position information of the aircraft 100 at time to, it may be determinable that the aircraft 100 is nearing or at the edge of the coverage area of the first BS 110 at time to.

A second BS 130, which may have similar performance and functional characteristics to those of the first BS 110, may be located geographically such that, for the current track or trajectory of the aircraft 100, the second BS 130 is a candidate for handover of the aircraft 100 to maintain a continuous and uninterrupted communication link between the aircraft 100 and ground-based base stations of an ATG wireless communication network at time to. As discussed above, it may be helpful for the second BS 130 to be aware of the approach of the aircraft 100 so that the second BS 130 can employ beamforming techniques to direct a beam toward the aircraft 100 either when or prior to the aircraft 100 reaching the coverage area of the second BS 130. Additionally or alternatively, it may be helpful for the aircraft 100 to be aware of the existence and location of the second BS 130 so that the wireless communication equipment on the aircraft 100 may employ beamforming techniques to direct a beam toward the second BS 130 either when or prior to the aircraft 100 reaching the coverage area of the second BS 130. Thus, at least one of the second BS 130 or the wireless communication equipment on the aircraft 100 may employ beamforming techniques assisted by knowledge of position information to facilitate establishment of the wireless communication link 140 between the wireless communication equipment on the aircraft 100 and the second BS 130. The handover of the aircraft 100 from the first BS 110 to the second BS 130 at time to may be followed by service of the aircraft 100 being provided by the wireless communication link 140 and the second BS 130.

In accordance with an example embodiment, a beamforming control module may be provided that employs both 2D knowledge of fixed base station location and at least 3D knowledge (perhaps 4D or 5D knowledge in some cases) of position information regarding a receiving station on an aircraft to assist in application of beamforming techniques. The beamforming control module of an example embodiment may be physically located at any of a number of different locations within an ATG communication network. For example, the beamforming control module may be located at the aircraft 100, at either or both of the first and second BS 110 and 130, or at another location in the network or in the cloud. Similarly, a module or tracking engine may also be located at the aircraft 100, at either or both of the first and second BS 110 and 130, or at another location in the network or in the cloud. The module or tracking engine may utilize position information, either independently gathered, or gathered in association with beamforming as described above, to generate and track trajectory information for one or more of the aircraft that are being tracked by the system. Example embodiments may include modules or components that are configured not only to track these trajectories, but to continuously monitor and update possible trajectories associated with one or more of the aircraft so that, for example, optimized routes can be suggested with respect to individually selectable parameters (e.g., time, fuel cost, carbon footprint, contrail generation, turbulence avoidance, wireless connectivity, bandwidth, quality of service, etc.). Example embodiments may then further determine (e.g., via utilization of cumulative distribution functions or other probabilistic methods) a degree to which optimized routes calculated in light of built-in constraints are to be modified to accommodate the inclusion of user defined constraints as described herein. The original route that was calculated as an optimized route may then be shown with a newly suggested route that considers the user defined constraint (or constraints). However, in some cases, only the newly suggested route may be displayed. That said, some users may appreciate the ability to compare the routes visually and/or with data indicating the costs of any route changes so that any improvement or relative costs between routes may be presented to a viewer (e.g., a pilot, fleet manager or air traffic controller).

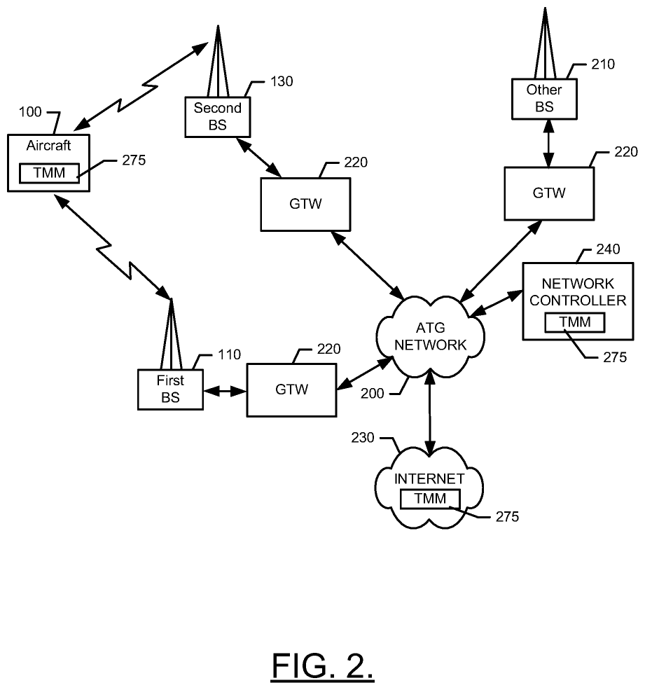

FIG. 2 illustrates a functional block diagram of a system that may include an ATG communication network and corresponding terrestrial network or Internet connected network that may employ an example embodiment of a device for continuously planning and evaluating trajectory information and augmenting such information with a user defined constraint module of an example embodiment.

As shown in FIG. 2, the first BS 110 and second BS 130 may each be base stations of an ATG network 200. The ATG network 200 may further include other BSs 210, and each of the BSs may be in communication with the ATG network 200 via a gateway (GTW) device 220. The ATG network 200 may further be in communication with a wide area network such as the Internet 230 or other communication networks. In some embodiments, the ATG network 200 may include or otherwise be coupled to a packet-switched core network.

In an example embodiment, the ATG network 200 may include a network controller 240 that may include, for example, switching functionality. Thus, for example, the network controller 240 may be configured to handle routing calls to and from the aircraft 100 (or to communication equipment on the aircraft 100) and/or handle other data or communication transfers between the communication equipment on the aircraft 100 and the ATG network 200. In some embodiments, the network controller 240 may function to provide a connection to landline trunks when the communication equipment on the aircraft 100 is involved in a call. In addition, the network controller 240 may be configured for controlling the forwarding of messages and/or data to and from a mobile terminal on the aircraft 100 and may also control the forwarding of messages for the base stations. It should be noted that although the network controller 240 is shown in the system of FIG. 2, the network controller 240 is merely an exemplary network device and example embodiments are not limited to use in a network employing the network controller 240.

The network controller 240 may be coupled to a data network, such as a local area network (LAN), a metropolitan area network (MAN), and/or a wide area network (WAN) (e.g., the Internet 230) and may be directly or indirectly coupled to the data network. In turn, devices such as processing elements (e.g., personal computers, laptop computers, smartphones, server computers or the like) can be coupled to the communication equipment on the aircraft 100 via the Internet 230.

Although not every element of every possible embodiment of the ATG network 200 is shown and described herein, it should be appreciated that the communication equipment on the aircraft 100 may be coupled to one or more of any of a number of different networks through the ATG network 200. In this regard, the network(s) can be capable of supporting communication in accordance with any one or more of a number of first-generation (1G), second-generation (2G), third-generation (3G), fourth-generation (4G), fifth generation (5G) and/or future mobile communication protocols or the like. In some cases, the communication supported may employ communication links defined using unlicensed band frequencies such as 2.4 GHz or 5.8 GHz. However, communications may be supported by other frequencies in licensed bands additionally or alternatively. Moreover, it may be possible to switch between licensed and unlicensed band communications (and/or satellite communications) under the control of the network controller 240 in some cases. Additionally, in some cases, the ATG network 200 may be augmented by or operate in parallel with an air-to-air or satellite communication system and switching may be performed to handle communications alternately between either the ATG network 200, the air-to-air system or the satellite communications system in some cases under the control of the network controller 240.

As discussed above, beamforming may be employed at each of the base stations such that the aircraft 100 (or communication equipment thereon) so that continuous and uninterrupted communication may be experienced at the aircraft 100 for the provision of ground services, conducting of calls, provision of data (e.g., access to the Internet 230), etc.

may be provided to the aircraft 100 (or communication equipment thereon—including user equipment). Moreover, the network controller 240 may ensure that the aircraft 100 (or communication equipment thereon) may be handed over between the base stations as the aircraft 100 moves between cell coverage areas of respective ones of the base stations. This provides real time connectivity to the aircraft 100 (and communication equipment thereon).

As indicated above, a trajectory management module (TMM) 275 (e.g., Flight 5D application module) may be employed on electronic equipment at either or both of the network side or the aircraft-side in example embodiments. Thus, in some embodiments, the TMM 275 may be implemented in a receiving station on the aircraft (e.g., a passenger device or device associated with the aircraft's communication system). In some embodiments, the

TMM 275 may be implemented in the network controller 240 or at some other network side entity. In some cases, the TMM 275 may be implemented at an entity located in the cloud (e.g., at a location that is operably coupled to the ATG network 200 via the Internet 230). Accordingly, FIG. 2 illustrates an instance of the TMM 275 at each of the aircraft 100, the network controller 240, and the Internet 230. However, it should be appreciated that example embodiments could include only one such component (at any one of the locations). Alternatively, the system could operate in a distributed fashion with multiple instances of the TMM 275 at any (or each) of the locations shown. Additionally, it should be appreciated that an instance of the TMM 275 may be (in some cases) located on each aircraft that is configured to communicate with the ATG network 200 and/or on each device (e.g., cell phone or other communication equipment) that can operate in accordance with example embodiments. In this regard, for example, user defined constraints could be enabled by downloading and running an application that configures the corresponding device to include an instance of the TMM 275, which incorporates a user defined constraints module as described herein.

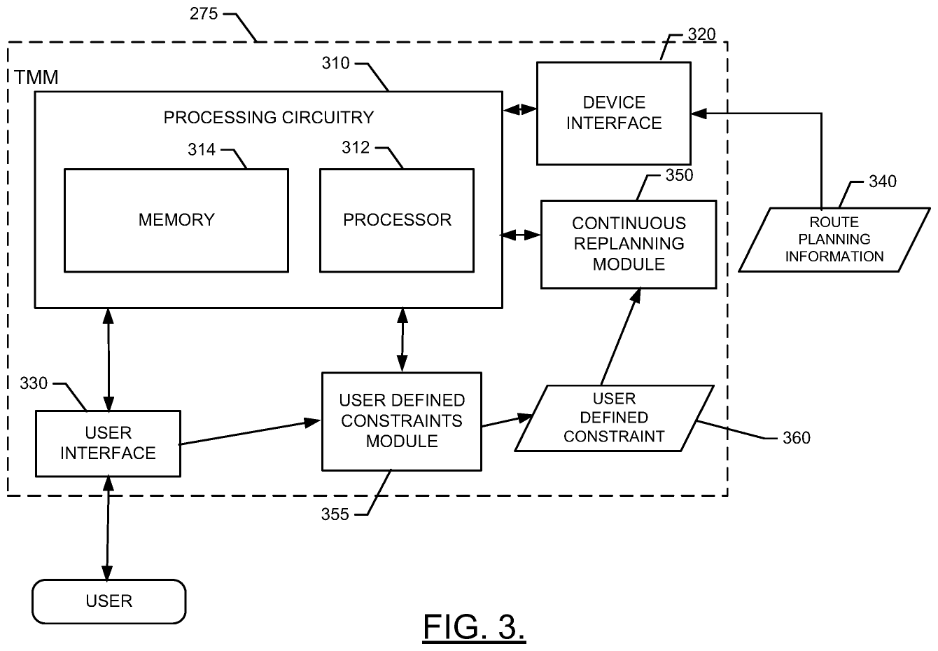

FIG. 3 illustrates the architecture of TMM 275 in accordance with an example embodiment. The TMM 275 may include processing circuitry 310 configured to perform data processing, control function execution and/or other processing and management services according to an example embodiment of the present invention. In some embodiments, the processing circuitry 310 may be embodied as a chip or chip set. In other words, the processing circuitry 310 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 310 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 310 may include one or more instances of a processor 312 and memory 314 that may be in communication with or otherwise control a device interface 320 and, in some cases, a user interface 330. As such, the processing circuitry 310 may be embodied as a circuit chip (e.g., an integrated circuit chip) configured (e.g., with hardware, software or a combination of hardware and software) to perform operations described herein. In some embodiments, the processing circuitry 310 may be embodied as a portion of an on-board computer, or other device on the aircraft 100, or a device at any portion of the ATG network 200 (including, as examples, a server, laptop, personal computer, or smart phone/tablet). In some embodiments, the processing circuitry 310 may communicate with various components, entities and/or sensors of the ATG network 200 and/or other services (e.g., weather, aircraft flight control/management/maintenance, etc.) to receive information to be considered or used by the TMM 275. As noted above, the real-time connectivity link of the ATG network 200 may facilitate the provision of such information, particularly when the TMM 275 is partly or wholly embodied on airborne devices.

The user interface 330 may be in communication with the processing circuitry 310 to receive an indication of a user input at the user interface 330 and/or to provide an audible, visual, mechanical or other output to the user. As such, the user interface 330 may include, for example, a display (e.g., a touchscreen or other display), a keyboard, a mouse, speakers, one or more levers, switches, indicator lights, buttons or keys (e.g., function buttons), and/or other input/output mechanisms capable of delivering audible, visual, haptic or other outputs. For cases where the TMM 275 is a thin client in the air, the user interface 330 may be at one device (i.e., the airborne thin client) whereas a majority of the processing power of the TMM 275 may be instantiated on the ground and at a different device. Thus, the user interface 330 may actually be separate from the TMM 275 and/or the device at which the TMM 275 is implemented, or may be instantiated at one or more of multiple distributed instances of the TMM 275. Meanwhile, in other cases, every instance of the TMM 275 may have a corresponding instance of the user interface 330.

The device interface 320 may include one or more interface mechanisms for enabling communication with other devices (e.g., modules, entities, sensors and/or other components of the ATG network 200 or on the aircraft 100 or other devices when the TMM 275 is instantiated on the aircraft 100 or devices thereon). In some cases, the device interface 320 may be any means such as a device or circuitry embodied in either hardware, or a combination of hardware and software that is configured to receive and/or transmit data from/to modules, entities, sensors and/or other components of the host device or the ATG network 200 or the internet 230 that are in communication with the processing circuitry 310.

The processor 312 may be embodied in a number of different ways. For example, the processor 312 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 312 may be configured to execute instructions stored in the memory 314 or otherwise accessible to the processor 312. As such, whether configured by hardware or by a combination of hardware and software, the processor 312 may represent an entity (e.g., physically embodied in circuitry — in the form of processing circuitry 310) capable of performing operations according to embodiments of the present invention while configured accordingly. Thus, for example, when the processor 312 is embodied as an ASIC, FPGA or the like, the processor 312 may be specifically configured hardware for conducting the operations described herein. Alternatively, as another example, when the processor 312 is embodied as an executor of software instructions, the instructions may specifically configure the processor 312 to perform the operations described herein.

In an example embodiment, the processor 312 (or the processing circuitry 310) may be embodied as, include or otherwise control the operation of the TMM 275 based on inputs received by the processing circuitry 310 including route planning information 340 associated with flight planning and optimization. Such route planning information 340 may include, for example, data and information relevant to the airspace and environment within which an aircraft operates including nearby airports, geographical features, weather (based on weather service information), wind, airspace management information, etc. The route planning information 340 may also include parameters specific to the aircraft 100 (or aircraft type), airspace exclusions, architectures and procedures, winds and temperatures aloft, storms, icing, volcanic ash, turbulence, and other air traffic, including air traffic management flow control initiatives for congestion management for air segments, and/or the like. The TMM 275 may be configured to receive the route planning information 340 including data/information associated with pilot or operator policies and preferences for desired time of arrival, avoidance of turbulence or icing or other flight hazards, fuel burn minimization, and cost minimization, which may define sensitivity or other parameters that alter built-in constraints. In most cases, the route planning information 340 is dealt with by the TMM 275 in terms of receipt and processing in a fairly conventional way using responses that are built-in in the manner described above.

In some embodiments, the processor 312 (or the processing circuitry 310) may be said to cause each of the operations described in connection with the TMM 275 (and/or the components or modules thereof) including operations in relation to processing the information described above, and also user defined constraints as described herein to undertake the corresponding functionalities relating to providing continuous replanning of one or more potentially dynamically interacting trajectories to generate a guidance output (e.g., a pilot advisory recommendation regarding path optimization options) responsive to execution of instructions or algorithms configuring the processor 312 (or processing circuitry 310) accordingly.

In an exemplary embodiment, the memory 314 may include one or more non-transitory memory devices such as, for example, volatile and/or non-volatile memory that may be either fixed or removable. The memory 314 may be configured to store information, data, applications, instructions or the like for enabling the processing circuitry 310 to carry out various functions in accordance with exemplary embodiments of the present invention. For example, the memory 314 could be configured to buffer input data for processing by the processor 312. Additionally, or alternatively, the memory 314 could be configured to store instructions for execution by the processor 312. As yet another alternative, the memory 314 may include one or more databases that may store a variety of data sets responsive to input sensors and components. Among the contents of the memory 314, applications and/or instructions may be stored for execution by the processor 312 in order to carry out the functionality associated with each respective application/instruction. In some cases, the applications may include instructions for providing inputs to control operation of the TMM 275 as described herein. In an example embodiment, the memory 314 may store fixed parameters and dynamic parameters that are provided continually or periodically as updates (e.g., weather and traffic information) that are associated with built-in constraints.

The TMM 275 may be implemented in a system that comprises additional modules that may each include their own respective processing circuitry components, or that may operate under the control of the processing circuitry 310. The modules of or in communication with the TMM 275 may include components that operate in connection with or as parts of the device interface 320 and/or the user interface 330.

In an example embodiment, the TMM 275 may include or otherwise be in communication with a continuous replanning module 350. The continuous replanning module 350 may be embodied as a computational engine for flight path (trajectory) management. An example of a suitable computational engine capable of continuous re-planning of five-dimensional trajectories, is disclosed in commonly assigned U.S. Pat. No. 8,594,917, entitled “Method And Apparatus For Dynamic Aircraft Trajectory Management” and U.S. Pat. No. 8,554,458, entitled “System and Method for Planning, Disruption Management, and Optimization of Networked, Scheduled or On-Demand Air Transport Fleet Trajectory Operations,” the contents of each of which are hereby incorporated by reference in their entireties. The continuous replanning module 350 may include or otherwise be operably coupled to a user defined constraint module 355 as described in greater detail below.

The continuous replanning module 350 may be configured to evaluate the five-dimensional trajectories of aircraft in order to define an optimized route from the perspective of one or more of such aircraft (e.g., aircraft 100) in light of the route planning information 340. The route planning information 340 may be directly provided to the continuous replanning module 350, or may be provided indirectly (e.g., via the device interface 320). As such, the continuous replanning module 350 may be configured to enable route optimization across multiple different selectable parameters and further enable balancing of the optimization efforts across parameters in relation to built-in constraints and user defined constraints 360 (generated by the user defined constraints module 355. For example, the continuous replanning module 350 may be configured to evaluate and define optimized routes based on cumulative distribution function and/or plot probability based comparisons of one or more trajectories or paths for one or more aircraft.

The user defined constraints module 355 may be configured to enable a user (e.g., via the user interface 330) to enter and define one or more instances of the user define constraint 360 for provision to the continuous replanning module 350. The user defined constraint 360 (as noted above) may be defined as a multi-dimensional object inserted by the user and including both space (e.g., 3D geometric shape) and time dimensions (e.g., start and end time). The object defined by the user defined constraint 360 may therefore have a minimum altitude, maximum altitude, boundaries in latitude and longitudinal coordinates on its sides, and may exist for a given period of time. Moreover, the object may be enabled to move with defined speed and direction (or change in direction) parameters. The geometry of the object may be defined using GeoJSON format, or any other suitable geometric format, and may be designated for avoidance as an exclusionary user defined constraint or inclusion as an inclusionary user defined constraint for consideration along with other objects associated with built-in constraints during route determination (or route optimization) conducted by the continuous replanning module 350.

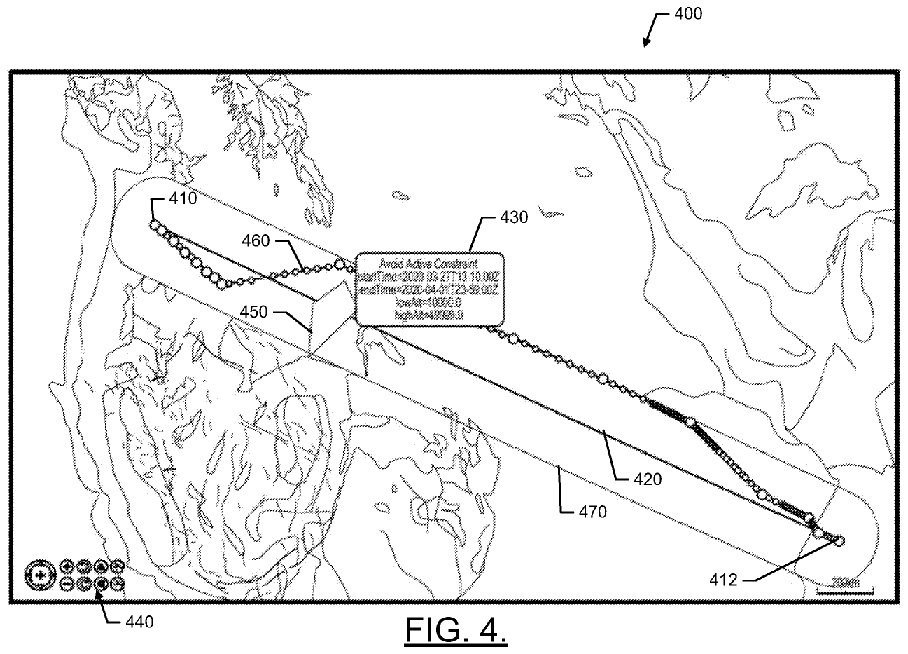

FIG. 4 illustrates a display screen 400 that may be generated at the user interface 330 based on operation of the TMM 275 in accordance with an example embodiment. In this regard, FIG. 4 illustrates a starting location 410 and a destination 412 for a planned flight from the western US to a location in the central US. FIG. 4 also illustrates a planned flight path 420 generated by the continuous replanning module 350 between the starting location 410 and the destination 412. The planned flight path 420 may be generated based on the route planning information 340 as shown in FIG. 3. As such, the planned flight path 420 may be understood to have been generated based on built-in constraints associated with the system.

Shortly after takeoff, a user defined constraint entry 430 may be provided using screen interface controls 440. However, it should be appreciated that the user defined constraint entry 430 could alternatively be provided at any other time during the flight, and could even be input prior to takeoff in some cases. Based on the user defined constraint entry 430, an object 450 may be provided on the display screen 400. The object 450, as noted above, includes a geometric shape with a minimum and maximum altitude, along with boundaries defining sides of the object 450. The object 450 also includes a start time and an end time. Moreover, as noted in FIG. 4, the object 450 also includes a status identifier, which indicates that the object 450 is to be avoided. Thus, the object 450 is an example of an exclusionary user defined constraint.

An updated flight path 460 may be generated based on employment of an optimization strategy by the continuous replanning module 350 in light of the object 450, and the updated flight path 460 is also shown on the display screen 400. Over time, to the extent the updated flight path 460 is followed, waypoints (e.g., the circles along the updated flight path 460) may be plotted to correspond to the updated flight path 460 (or the actual flight path flow, if different from the updated flight path 460).

Of note, FIG. 4 also illustrates a corridor 470. In some cases, the corridor 470 may also be an object generated based on an inclusionary user defined constraint. For example, the corridor 470 may be defined to identify a path via which the aircraft 100 could fly from the starting location 410 to the destination 412 while maintaining the best wireless communication connectivity, bandwidth or quality of service. As such, the corridor 470 may be considered an example of the inclusionary user defined constraint.

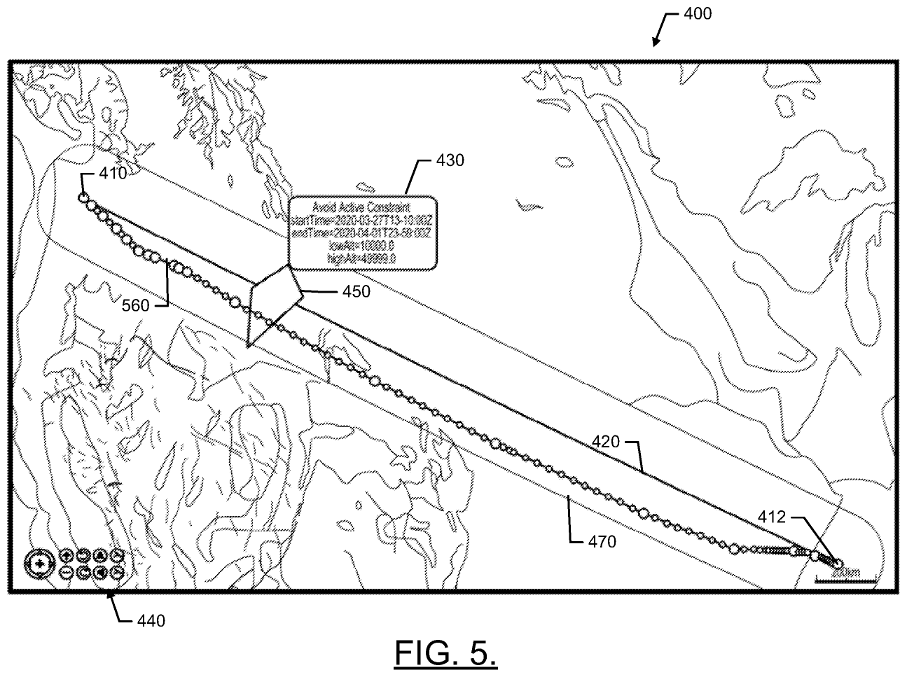

In the example of FIG. 4, the updated flight path 460 is generated to steer around the object 450. However, since the object 450 is bounded in altitude, it may also be possible to instead travel over or below the object 450. In this regard, the example of FIG. 5 illustrates a similar scenario as that of FIG. 4. However, in the example of FIG. 5, updated flight path 560 travels over the top of the object 450 (i.e., above the altitude limit defined for the object 450).

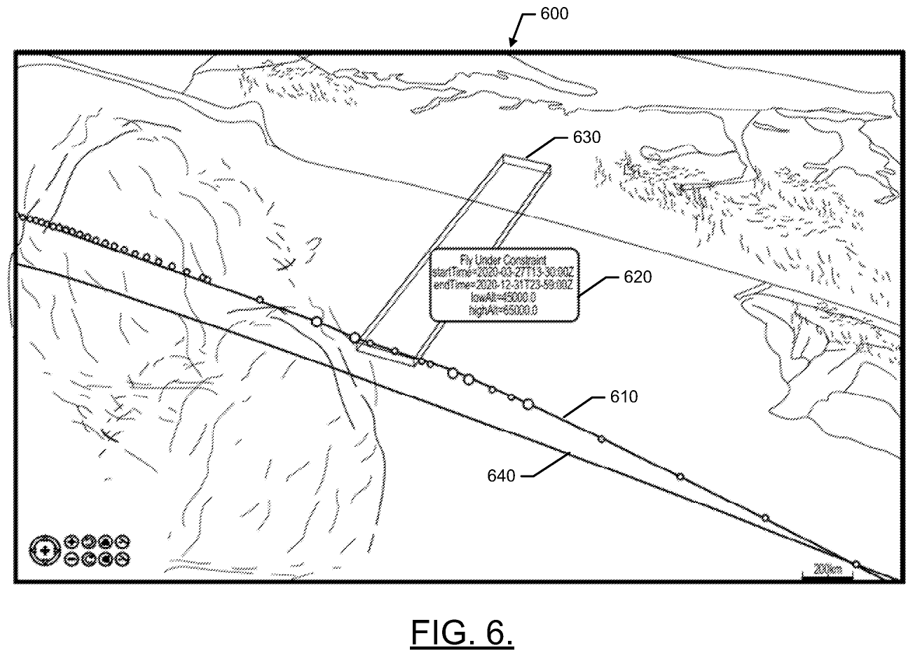

FIG. 6 illustrates another example display screen 600 showing a portion of planned flight path 610 (notably this time the planned flight path 610 has circles thereon). The user defined constraint entry 620 is shown to be an exclusionary user defined constraint, and object 630 has been generated based on the user defined constraint entry 620. As shown in FIG. 6, the used defined constraint entry 620 further suggests (e.g., due to an evaluation of the relatively high floor for the object 630) that the updated flight path 640 should go under the object 630. Moreover, FIG. 6 further illustrates the updated flight path 640 diverging from the planned flight path 610 to pass under the object 630.

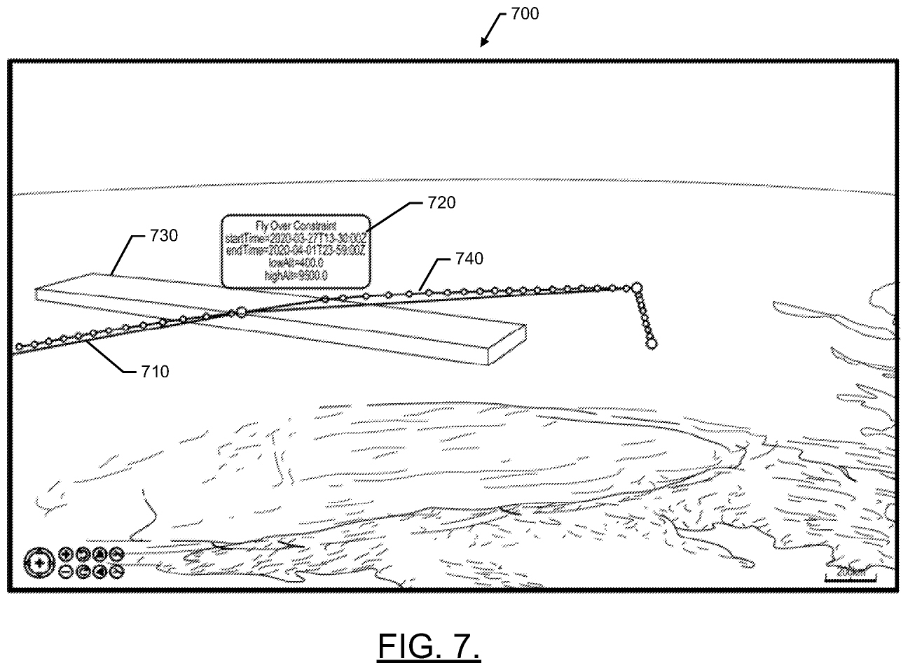

FIG. 7 illustrates another example display screen 700 showing a portion of planned flight path 710 (notably this time the planned flight path 710 is without circles thereon). The user defined constraint entry 720 is shown to be an exclusionary user defined constraint, and object 730 has been generated based on the user defined constraint entry 720. As shown in FIG. 7, the used defined constraint entry 720 further suggests (e.g., due to an evaluation of the relatively low ceiling for the object 730) that the updated flight path 740 should go over the object 730. Moreover, FIG. 7 further illustrates the updated flight path 740 diverging from the planned flight path 710 to pass over the object 730.

Accordingly, for example, the TMM 275 may be configured to consider built-in constraints relative to the route planning information 340, but may also consider user defined constraints for the same. As such, the TMM 275 considers multiple aircraft trajectories (e.g., via the continuous replanning module 350), but also receives real time updates to certain current or future constraints (e.g., user defined constraints 360) that may affect the flight path of the aircraft 100. Based on the user defined constraints 360, built-in constraints, and the route planning information, the TMM 275 may consider all factors that may impact flight path optimization (e.g., including some factors set by the pilot or an operator, and some factors that may be dynamically changing such as weather and traffic patterns) to output a flight guidance or updated flight path graphically.

The TMM 275, interdependently supported by a high bi-directional bandwidth, low latency connectivity system, provides a capability for enhancing the capabilities of pilots and flight planners or controllers to plan airspace management, and also deal with issues that arise in relation to a specific area in real time for management and optimization in the context of continuously changing conditions, and user policies and preferences. The TMM 275 is generally founded on the concept of continuous re-planning of dynamically interacting flight paths (trajectories) that, for the first time, enable consideration of objects/constraints that may be user defined. The TMM 275 is configured to ingest data about observations and forecasts of atmospheric conditions, airspace status, and traffic, through data communications technology, to make the computations of future flight and ground paths that satisfy user preferences, trajectory economics, and safety that are capable of being entered in connection with user defined constraints while the aircraft 100 is in-flight.

The system of FIG. 2 may therefore include one or more TMMs 275 at one or more corresponding locations within the system. Regardless of the number and locations of such modules, the information associated therewith may be used to generate flight path updates that can be provided, for example, to an operator, pilot, flight controller, etc., at either end of a two-way communication link. Example embodiments may therefore provide highly capable, in-flight/enroute advisory services that consider dynamic parameters and the desires or business imperatives of a driver, pilot or operator. Proactive resource management, safety related advisory services, and other activities may then be undertaken to improve system performance and customer satisfaction. A typical use case may include a pilot using the TMM 275 to input a user defined constraint and generate an updated flight path based on the exclusionary or inclusionary object generated accordingly. If the TMM 275 is embodied in a thin client scenario, the main processing for the TMM 275 may be on the ground and the user interface 330 may be in the air. However, it is possible that the entire TMM 275 is embodied on the aircraft. In still other examples, a flight controller can (entirely on the ground) provide the user defined constraint (or constraints), and the updated flight path may then be communicated to the aircraft 100 (or multiple aircraft simultaneously) in the air. Combinations of the above scenarios could also exist.

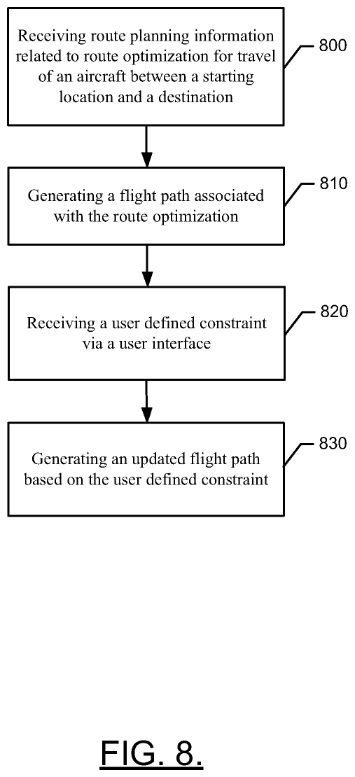

As such, the system of FIG. 2 may provide an environment in which the trajectory management module of FIG. 3 may provide a mechanism via which a number of useful methods may be practiced. FIG. 8 illustrates a block diagram of one method that may be associated with the system of FIG. 2 and the modules of FIG. 3. From a technical perspective, the TMM 275 described above may be used to support some or all of the operations described in FIG. 8. As such, the platform described in FIG. 2 may be used to facilitate the implementation of several computer program and/or network communication-based interactions. As an example, FIG. 8 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a device (e.g., the TMM 275, and/or the like) and executed by a processor in the device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 8, may include receiving route planning information related to route optimization for travel of an aircraft between a starting location and a destination at operation 800. The method may further include generating a flight path associated with the route optimization at operation 810 and receiving a user defined constraint via a user interface at operation 820.

The method may further include generating an updated flight path based on the user defined constraint at operation 830. The updated flight path may be generated, for example, based on the user defined constraint and other flight path constraints which may be integrated in combination with user defined constraints.

In some cases, a trajectory management module capable of performing the method above may be provided. The module may include processing circuitry configured to perform the operations of the method. The method described above in reference to FIG. 8 may include additional steps, modifications, augmentations and/or the like to achieve further objectives or enhance operation of the system. Similarly, the module described above may include additional features, modifications, augmentations and/or the like. The additional steps, features, modifications, augmentations and/or the like may be added in any combination with each other. For example, in some cases, the user defined constraint may be a multi-dimensional object inserted by the user into a route tracking or optimization system configured to execute the method. In an example embodiment, the multi-dimensional object may be defined as a three dimensional geometric shape having a start and end time. In some cases, the three dimensional geometric shape may include a minimum altitude, a maximum altitude, and boundaries in latitude and longitudinal coordinates on sides of the multi-dimensional object. In an example embodiment, the multi-dimensional object may further include a moving direction and a corresponding moving speed. In some cases, the three dimensional geometric shape may be defined using GeoJSON format. In an example embodiment, the user defined constraint may be an exclusionary user defined constraint indicating a region to be avoided during the route optimization. In some cases, user defined constraint may be an inclusionary user defined constraint indicating a region inside which the aircraft is to stay during the route optimization. In an example embodiment, the inclusionary user defined constraint may be determined based on wireless connectivity from an air-to-ground network to the aircraft while the aircraft is inside the region. In some cases, the user defined constraint may include both an exclusionary user defined constraint indicating a region to be avoided during the route optimization and an inclusionary user defined constraint indicating a region inside which the aircraft is to stay during the route optimization.

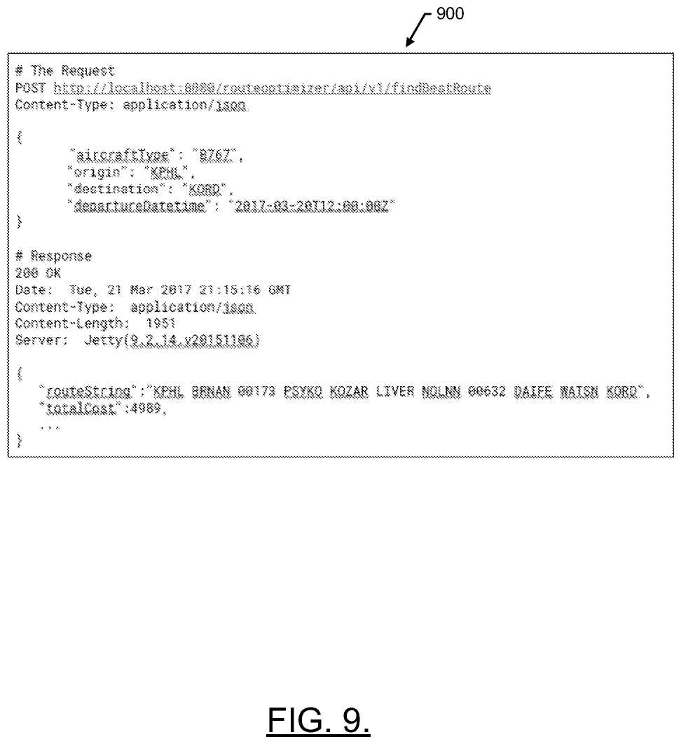

In some embodiments, the user defined constraints module 355 and/or the continuous replanning module 350 may include a number of HTTP interface elements that can be employed to define the user defined constraint 360 and/or information associated therewith. Although these interface elements could vary, and could be modified to include new or different functionalities, some standard interface elements could apply in many scenarios. For example, generic sets of HTTP methods may be defined for finding an optimized route (if it exists) from a valid origin to a valid destination (e.g., airports) employing any user defined or built-in constraints identified, or for finding an optimized route (if it exists) from a current position (enroute) to a valid destination (e.g., airport) employing any user defined or built-in constraints identified. Other HTTP methods may find optimized routes from a valid origin to or clearable route network node to another clearable route network node or a valid destination employing any user defined or built-in constraints identified. Processing could also be performed pre-flight, during a flight, or post-flight. An example of code used to find a best route preflight is shown in FIG. 9 as example code table 900.

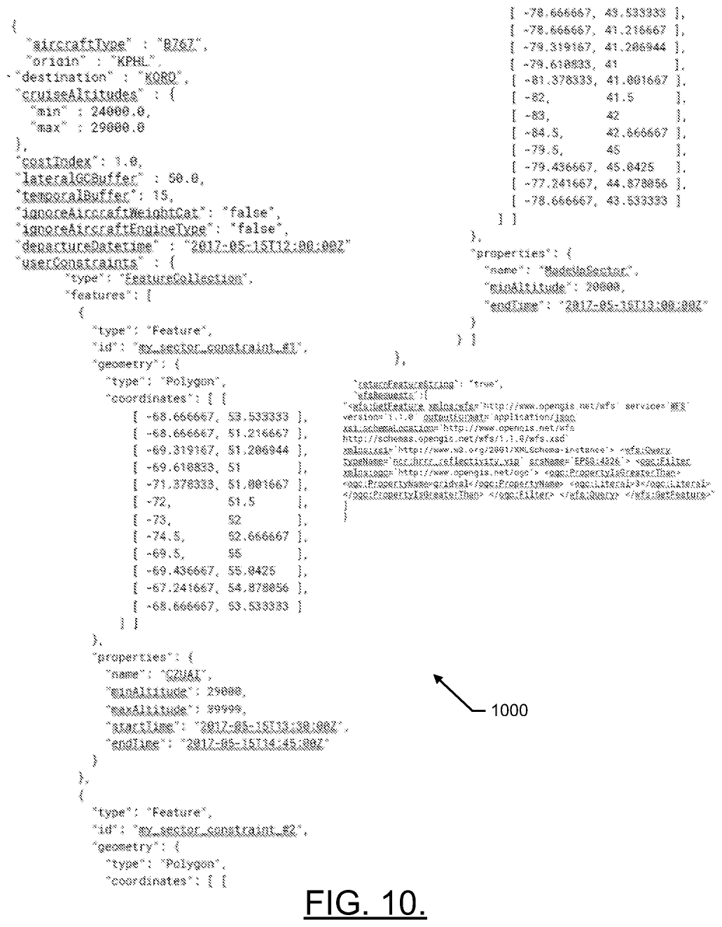

As noted above, route optimization could include information including the type of aircraft, performance model parameters for the type of aircraft, and other information. The origin and destination may be provided using valid airports or clearable route network nodes. Cruise altitudes may be defined to include maximum and minimum cruise altitudes. Of course, the continuous replanning module 350 will not select any route that would go above the maximum or below the minimum cruise altitude in order to avoid an object. Lateral great circle buffers may be defined as maximum limits in deviation from a great circle route for avoidance of an object. Aircraft weight, engine type and other specific parameters about the aircraft or aircraft type may be selected for consideration, or may be ignored in some cases. Cost index information may be provided in a cost index field, and custom (i.e., user defined) constraints may also be added as described above. FIG. 10 illustrates example code 1000 (extending in a column on the left side of the page, and then continuing on the right side of the page) that may be used employing the methods and interfaces described above in one embodiment.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A method comprising:
receiving route planning information related to route optimization for travel of an aircraft between a starting location and a destination;
generating a flight path associated with the route optimization;
receiving a user defined constraint via a user interface; and
generating an updated flight path based on the user defined constraint.

2. The method of claim 1, wherein the user defined constraint is a multi-dimensional object inserted by the user into a route tracking or optimization system configured to execute the method.

3. The method of claim 2, wherein the multi-dimensional object is defined as a three-dimensional geometric shape having a start and end time.

4. The method of claim 3, wherein the three-dimensional geometric shape includes a minimum altitude, a maximum altitude, and boundaries in latitude and longitudinal coordinates on sides of the multi-dimensional object.

5. The method of claim 3, wherein the multi-dimensional object further comprises a moving direction and a corresponding moving speed.

6. The method of claim 3, wherein the three-dimensional geometric shape is defined using GeoJSON format.

7. The method of claim 1, wherein the user defined constraint is an exclusionary user defined constraint indicating a region to be avoided during the route optimization.

8. The method of claim 1, wherein user defined constraint is an inclusionary user defined constraint indicating a region inside which the aircraft is to stay during the route optimization.

9. The method of claim 8, wherein the inclusionary user defined constraint is determined based on wireless connectivity from an air-to-ground network to the aircraft while the aircraft is inside the region.

10. The method of claim 1, wherein the user defined constraint includes both an exclusionary user defined constraint indicating a region to be avoided during the route optimization and an inclusionary user defined constraint indicating a region inside which the aircraft is to stay during the route optimization.

11. A trajectory management module comprising processing circuitry configured to:
receive route planning information related to route optimization for travel of an aircraft between a starting location and a destination;
generate a flight path associated with the route optimization;
receive a user defined constraint via a user interface; and
generate an updated flight path based on the user defined constraint.

12. The trajectory management module of claim 11, wherein the user defined constraint is a multi-dimensional object inserted by the user into a route tracking or optimization system configured to execute the method.

13. The trajectory management module of claim 12, wherein the multi-dimensional object is defined as a three dimensional geometric shape having a start and end time.

14. The trajectory management module of claim 13, wherein the three dimensional geometric shape includes a minimum altitude, a maximum altitude, and boundaries in latitude and longitudinal coordinates on sides of the multi-dimensional object.

15. The trajectory management module of claim 13, wherein the multi-dimensional object further comprises a moving direction and a corresponding moving speed.

16. The trajectory management module of claim 13, wherein the three-dimensional geometric shape is defined using GeoJSON format.

17. The trajectory management module of claim 11, wherein the user defined constraint is an exclusionary user defined constraint indicating a region to be avoided during the route optimization.

18. The trajectory management module of claim 11, wherein user defined constraint is an inclusionary user defined constraint indicating a region inside which the aircraft is to stay during the route optimization.

19. The trajectory management module of claim 18, wherein the inclusionary user defined constraint is determined based on wireless connectivity from an air-to-ground network to the aircraft while the aircraft is inside the region.

20. The trajectory management module of claim 11, wherein the user defined constraint includes both an exclusionary user defined constraint indicating a region to be avoided during the route optimization and an inclusionary user defined constraint indicating a region inside which the aircraft is to stay during the route optimization.
